(19) United States
(12) Patent Application Publication
(10) Pub. No.: US 2010/0276395 A1
(43) Pub. Date: Nov. 4, 2010

(54) 35kV Rubber Molded Fused Vacuum Interrupter

(75) Inventor: Daniel Lee Gardner, Stewartsville, NJ (US)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/766,992

(22) Filed: Apr. 26, 2010

Related U.S. Application Data
(60) Provisional application No. 61/214,874, filed on Apr. 29, 2009.

(51) Int. Cl. H01H 33/66

(52) U.S. Cl. 218/138

(57) ABSTRACT

A high voltage, preferably 35 kV, rubber molded fused vacuum interrupter assembly for protecting an electrical circuit from fault currents. The assembly includes one or more vacuum fault interrupters; one or more current limiting fuses; one or more sensing modules and a control module. Each of the vacuum fault interrupters is contained in a molded insulating structure and each of the current limiting fuses is encapsulated in a rubber molding. For each phase of the electrical circuit, a vacuum fault interrupter and a current limiting fuse are connected in series. The sensing modules measure the current in the lines. The vacuum fault interrupter interrupts low current faults and the fuse operates to protect against high current faults in a high voltage electrical power line. A three-phase electrical circuit would have three vacuum fault interrupters and three current limiting fuses.

This application claims priority from provisional application Ser. No. 61/214,874, filed on Apr. 29, 2009, which is incorporated herein in its entirety.

### FIELD OF THE INVENTION

The present invention relates to high voltage vacuum interrupters. In particular, the present invention relates to dead front, rubber molded, fused, vacuum interrupter assemblies that can be used in high voltages systems up to 35 kV.

### BACKGROUND OF INVENTION

Dead-front current and energy limiting fault protection is commonly provided in systems with voltages of up to 23 kV using rubber molded, full-range, current-limiting fuses. Dead-front overload and fault protection in 35 kV systems can be provided using molded vacuum interrupters (“MVIs”). However, such devices do not current or energy limit and the rubber molded fuses that are currently available have been found to be unacceptable for such high voltage applications.

Modern full-range fuses are “self-protecting,” meaning that they melt under overload conditions before any components in the fuse can overheat and cause damage to the fuse assembly. When encapsulated in rubber, the heat is confined and heat loss is restricted so that the components of the fuse run hotter at lower currents. Rubber encapsulated full-range fuses self compensate for these conditions and melt more quickly, again before components can overheat and be damaged. This design characteristic of rubber encapsulated fuses makes it possible to rubber mold current-limiting fuses used in relatively low voltage applications (i.e., voltages less than 23 kV) without fear of damage to the fuse caused by overheating. The limiting factor in the design of these full-range fuses is the physical size of the fuse, especially the overall length. Attempts have been made to reduce the physical length of a high-voltage fuse with a fusible element by winding the element spirally around a core. While it is possible to rubber mold full-range, current-limiting fuses suitable for use at 35 kV in much the same manner as fuses used for voltages below 23 kV in order to provide dead-front current-limiting protection, the length of such high voltage fuses, which can be in excess of 35 inches, is prohibitive.

High voltage current-limiting fuses are used in a variety of applications to protect against over-currents in electrical equipment. A typical high-voltage current-limiting fuse includes a tubular insulating housing, an elongated core within the housing, and one or more fusible elements wound about the core and connected between terminals at opposite ends of the housing. A core is needed for fuses rated at 5 kilovolts (“kV”) and above in order to enable the fuse to accommodate the required length of fusible element within a housing of practical length. The fuse housing materials may consist of glass, ceramic, porcelain, and glass-filament-wound epoxy tubing. Typical housing lengths range from 8 to 38 inches for voltages up to about 35 kV.

The fusible elements are typically made of silver, copper or tin to provide stable and predictable performance. The resistance of the fusible element develops heat that causes a portion of the metal to melt or disintegrate upon reaching the melting temperature of the metal. This property allows accurate thermal activation of a fuse in response to a particular level of overload current. The thermal activation exhibits an inverse-time response curve so that a small overload generally takes a longer time to heat the metal and melt the fuse. As the overload current increases, the heating and melting time is reduced. Each fusible element has a melting time-current characteristic curve, which covers the range between the lowest current that causes the fuse to melt up to the rated interrupting current of the fuse.

As used herein in connection with fuses, the phrase “melting time” refers to the time period from the beginning of the failure current to the melting of the fuse element(s). The time/current characteristic curves provided by fuse manufacturers show the virtual melting time, which takes into consideration different curves and closing angles of the current.

Current-limiting backup fuses that are suitable for use at 35 kV are available and are commonly used to provide current-limiting protection in a much more compact package so that overall lengths can be as short as 18 inches. However, existing 35 kV fuses are always either installed inside a transformer or piece of switchgear submersed in oil or mounted in open air in what would be considered a “live-front” application. Current-limiting backup fuses are not self-protecting, meaning that if subjected to an overload condition, the fuse will overheat and its components will be damaged. Therefore, a series connected device that is designed to interrupt overloads must always be used in conjunction with the backup fuse. The devices most commonly used in such systems are expulsion fuses (a vented fuse unit in which the arc is extinguished by the expulsion of gases generated by the arc and lining of the fuse holder) or breakers.

While backup fuses suitable for 35 kV systems are of a desirable length for molding, they have not been rubber molded for use in dead-front applications because the rubber encapsulation restricts heat loss. The build up of heat inside the rubber molded encapsulation makes components run hotter at lower currents and makes it very difficult to provide the overload protection needed to keep the components of the fuse and the rubber molded encapsulation from overheating and being damaged. The melting time versus current curve for these thermal devices (expulsion fuses and breakers) shows that an unacceptably large current-limiting fuse would be required in order to prevent the fuse from overheating. This would result in an inconveniently long fuse with undesirable current and energy limiting characteristics.

In order to rubber mold any type of medium voltage current-limiting fuse, it is necessary to coat most of the outer surface of the fuse body with a thin layer of semi-conductive coating. Only a small gap at one end of the fuse is left uncoated. When the fuse is energized (before melting), this coating together with a corresponding layer, which is embedded in the rubber directly over the gap in the coating on the fuse, forms a “Faraday cage.” As used herein, the term Faraday cage refers to an enclosure formed by conducting material or by a mesh of such material that blocks out external static electrical fields. Putting a ground plane (needed to make the device dead-front) so close to the fuse elements, which are at high potential, creates stress and can lead to corona (also known as partial discharge). Corona is a type of localized emission resulting from transient gaseous ionization in an insulation system when the voltage stress, i.e., voltage gradient, exceeds a critical value. Over time corona can cause the elements to deteriorate and the fuse to fail. By creating a Faraday cage around the fuse, the voltage stress is removed from the elements and moved to the rubber insulation, which is designed to withstand the stress. While the fuse is carrying current, there is no voltage across the gap left on the outer surface of the fuse body. However, after the fuse interrupts, full voltage may appear across that gap. The gap must be able to withstand whatever voltage may pass across it after an interruption without breaking down and failing. Prior art devices have not been successful in creating a Faraday cage with a gap that can withstand 35 kV indefinitely.

The rubber molded vacuum interrupters are devices capable of making, carrying and automatically interrupting currents through 12,500 amperes symmetrical on 5-38 kV distribution systems. Typically, high voltage circuit interrupters are used to selectively interrupt the flow of electrical current through a circuit. As used herein, the term “high voltage” means a voltage greater than 23 kV. Two types of high voltage circuit are generally in use, dry high voltage circuit interrupter and wet high voltage circuit interrupters. The primary difference between the two high voltage circuit interrupters is that the wet type is filled with oil, or some other dielectric fluid.

Dry high voltage circuit interrupters typically include a vacuum interrupter encapsulated in an epoxy housing mounted to a frame. The vacuum interrupter includes a pair of electrodes, one being stationary and the other movable between an open position and a closed position to open and close the circuit. The movable electrode is typically mounted on the end of an operating rod which moves the moveable electrode between the open and closed positions. The operating rod typically extends from the vacuum interrupter to engage an actuating mechanism mounted in the frame. The operating rod is insulated from the electrode to prevent the operating rod from conducting high voltage electrically energy from the electrode to the frame.

The devices currently used to provide dead-front current and energy limiting fault protection using rubber molded, full-range, current-limiting fuses is limited to voltages of up to 23 kV. Attempts to provide a device for 35 kV systems have been unsuccessful. Accordingly, there is a need for a rubber molded, fused assembly that can withstand 35 kV for an extended time without failing.

### SUMMARY OF THE INVENTION

In accordance with the present invention, a high voltage, preferably 35 kV, rubber molded fused vacuum interrupter assembly for protecting an electrical circuit from fault currents is provided. The assembly includes one or more vacuum fault interrupters; one or more current limiting fuses; one or more sensing modules, at least one control module and, optionally, a controller. Each of the vacuum fault interrupters is contained in a molded insulating structure and each of the current limiting fuses is encapsulated in a rubber molding. For each phase of the electrical circuit, a vacuum fault interrupter and a current limiting fuse are connected in series. The vacuum fault interrupter interrupts low current faults and the fuse operates to protect against high current faults in a high voltage electrical power line. A single-phase electrical circuit would have one vacuum fault interrupter and one current limiting fuse. A three-phase electrical circuit would have three vacuum fault interrupters and three current limiting fuses.

Each of the sensing modules measures current passing through one of the vacuum fault interrupters and sends a current measurement signal to the control module. For three-phase systems, a separate control module can be used to control the interrupter for each phase or a single control module can be used to control the interrupters for all three of the phases. A time/current characteristic curve for each of the one or more interrupters is programmed in the control module and used to calculate the predetermined high voltage setting. When a current measurement signal equal to a predetermined high voltage setting is measured, the control module opens or trips the interrupter.

The high voltage rubber molded fused vacuum interrupter assembly can also include a controller for monitoring one or more of the control modules and for reprogramming the predetermined high voltage setting for each of the one or more interrupters. Each of the vacuum fault interrupters has a predetermined high voltage setting and each of the one or more current limiting fuses has a rated interrupting current. The rated interrupting current is greater than the predetermined high voltage setting so that the interrupter will trip before the melting point of the fuse is reached under operating conditions.

The one or more vacuum fault interrupters are individually controlled by one or more actuators. Each actuator switches one of the interrupters from a closed position, wherein current passes through the interrupter to an open (or “tripped”) position, wherein current does not pass through the interrupter. Preferably, the one or more actuators and at least one control module for operating the one or more actuators are contained in a mechanism housing.

A preferred high voltage rubber molded fused vacuum interrupter assembly is used for protecting a three-phase electrical circuit from fault currents. The assembly includes: three vacuum fault interrupters, three actuators, three sensing modules, at least one control module and three current limiting fuses. One control module can be used to control all three interrupters or each interrupter can have a dedicated control module. The current limiting fuses are individually encapsulated in a rubber molding and each of the vacuum fault interrupters is contained in a molded insulating structure. A time/current characteristic curve based on the characteristics of the fuse is programmed in the control module(s) for each of the vacuum interrupters and used to calculate a predetermined high voltage setting based on the design of the circuit. The three actuators individually control the vacuum fault interrupters and switch each interrupter from a closed position, wherein current passes through the interrupter to an open position, wherein current does not pass through the interrupter. The sensing modules measure current passing through each of the vacuum fault interrupters and send a current measurement signal to the control module.

One vacuum fault interrupter and one current limiting fuse are connected in series for each phase of the three-phase electrical circuit. The current limiting fuse has a rated interrupting current that is greater than the predetermined high voltage setting of the interrupter for each phase. When a voltage equal to the predetermined high voltage setting for one of the interrupters is measured, the control module opens at least one of the interrupters. The vacuum fault interrupter interrupts low current faults and the fuse operates to protect against high current faults in each phase of the three-phase electrical circuit. The assembly can also include a controller for monitoring the control module or control modules and for reprogramming the predetermined high voltage settings of the interrupters.

### BRIEF DESCRIPTION OF THE FIGURES

The preferred embodiments of the 35 kV rubber molded fused vacuum interrupter assembly of the present invention, as well as other objects, features and advantages of this invention, will be apparent from the accompanying drawings wherein:

FIG. 1 is a top view of an embodiment of the 35 kV rubber molded fused vacuum interrupter assembly of the present invention used for a three-phase electrical circuit.

FIG. 2 is a side view of the 35 kV rubber molded fused vacuum interrupter assembly shown in FIG. 1.

FIG. 3 is a view of the first end of the 35 kV rubber molded fused vacuum interrupter assembly shown in FIG. 1.

FIG. 4 is a view of the second end of the 35 kV rubber molded fused vacuum interrupter assembly shown in FIG. 1.

FIG. 5 is a peripheral, cut-away view of an embodiment of a fuse that can be used in the 35 kV rubber molded fused vacuum interrupter assembly of the present invention.

FIG. 6 is an electrical schematic of an embodiment of the 35 kV rubber molded fused vacuum interrupter assembly of the present invention.

FIG. 7 is a prior art time/current characteristic (“TCC”) curve for a vacuum interrupter.

### DESCRIPTION OF THE INVENTION

The present invention is directed to a 35 kV rubber molded fused vacuum interrupter assembly, which combines a rubber molded vacuum interrupter with a current-limiting backup fuse. This allows the current-limiting backup fuse to be rubber molded and creates a compact, fully “dead-front” protective device suitable for 35 kV systems. The device provides not only overload and fault protection, but also current and energy limiting protection. As used herein, the term “dead front” means that there are no voltages present on the operating side of the equipment.

The high voltage rubber molded fused vacuum interrupter assembly includes one or more vacuum fault interrupters in a molded insulating structure and one or more current limiting fuses encapsulated in a rubber molding. The vacuum interrupter assembly can be installed on a single-phase high voltage line or a three-phase electrical circuit (also referred to herein as a three-phase system). For the single-phase, high voltage line, one vacuum fault interrupter and one current limiting fuse are connected in series. For a three-phase system, three vacuum interrupters and three fuses are used to protect the system (one interrupter and one fuse connected in series for each of the three-phases). The vacuum fault interrupter interrupts low current faults and the current-limiting fuse operates to protect against high current faults.

The high voltage current-limiting fuses used are well know to those skilled in the art and fuses suitable for the present invention are disclosed in U.S. Pat. No. 5,903,209 to Stepniak; U.S. Pat. Nos. 5,670,926 and 6,642,833 to Ranjan et al.; U.S. Pat. No. 5,714,923 to Shea et al.; and U.S. Pat. No. 5,604,474 to Leach et al. All of these references are incorporated herein in their entirety. Typically, the manufacturers provide fuses curves that specify the operating characteristic of the fuse, which are used to design circuits to protect against high current conditions.

The rubber molded vacuum interrupters used in the rubber molded fused vacuum interrupter assembly can include high current switches as disclosed in U.S. Pat. Nos. 7,397,012 and 7,579,572 to Stepniak et al. and U.S. Pat. No. 7,579,571 to Siebens et al., all three of these references are incorporated herein in their entirety. Other rubber molded vacuum interrupters can be used to practice the invention, such as U.S. Pat. No. 6,130,394 to Högl; U.S. Pat. No. 6,747,234 to Traska et al.; and U.S. Pat. No. 7,148,441 to Daharsh et al., all of which are incorporated herein in their entirety.

In addition to a rubber molded vacuum interrupter and a rubber molded fuse, the vacuum interrupter assembly includes a self-powered control module with a sensing module that measures the current in the line. The control module and sensing module operate the interrupter and, preferably, do not require batteries or external power. The power to operate the control module is provided by the current in the line that is being monitored (e.g., the induced voltage from a pickup coil). The sensing module measures the current through the interrupter and sends a signal to the control module, which continuously monitors the current and, if an over-current condition is detected, sends a signal to the vacuum interrupters to trip open and interrupt the fault. The assembly can also include an electronic control package (also referred to herein as a “controller”) that provides additional functionality, as described in more detail below. The vacuum interrupter is operated by an actuator enclosed in a mechanism housing that can include a handle for manual operation. In preferred embodiments, the mechanism housing can also contain the actuator(s) for operating the vacuum interrupter(s).

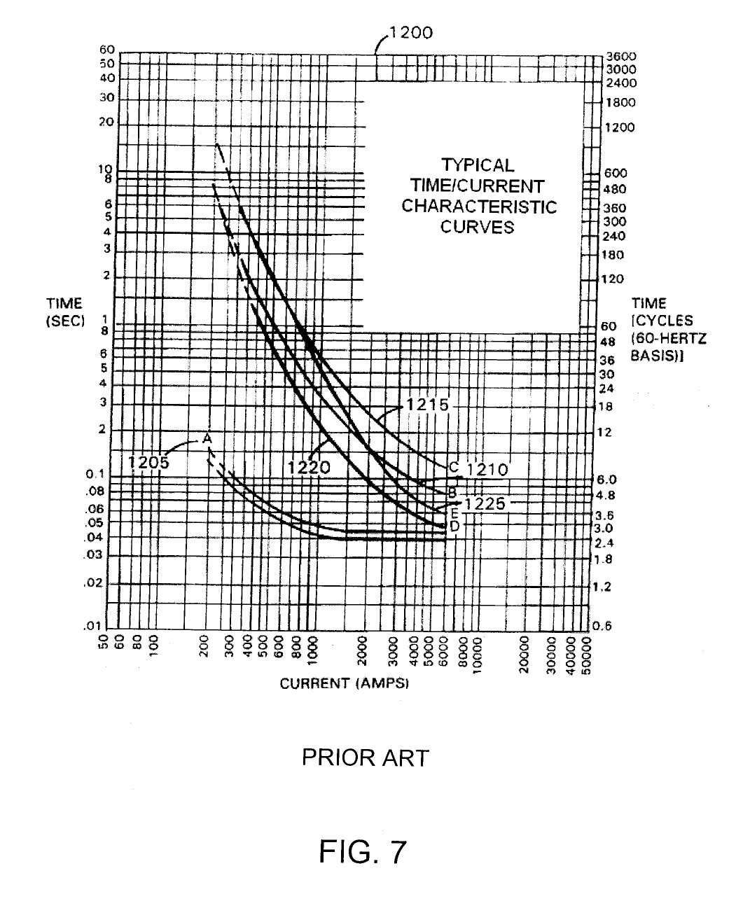

The term “interrupts” as used herein in connection with a vacuum fault interrupter means that the vacuum fault interrupter is switched (also referred to herein as tripped or opened) from a closed position, wherein current passes through the interrupter, to an open position, wherein current does not pass through the interrupter. As used herein in connection with interrupters, the phrase “time/current characteristic curve” (TCC) refers to curves provided by interrupter manufactures, which show the characteristics of the interrupters on a graph that plots time against current, based on the type of fuse that is connected in series with the interrupter. Some time/current characteristic curves plot tripping time versus percent of rated current for the interrupter. A typical plot for a prior art interrupter is shown in FIG. 7.

The control module and sensing module are preferably formed as an integral part of the assembly. The sensing module is positioned in close proximity to the power line and measures the current passing through using any of several well known methods that are based on different physical effects such as magnetic coupling, magneto resistance, Faraday induction, Hall effect and zero flux. The current passing through the sensing module induces a current which is compared in the control module to programmed logic. The logic is programmed based on the particular application, including the fuse specifications (as discussed above) and the time/current characteristics of the vacuum interrupter. The electronic controls then output a signal to an actuator (e.g., an electrical or magnetic actuator) that opens the vacuum interrupter based on the trip settings that have been programmed. Preferably, the control module has a standard computer port for interfacing with a computer device such as a lap top or a personal computer, which is used to program the control module.

In preferred embodiments, the control program includes a time delay that delays the tripping of the interrupter until the voltage exceeds the high voltage setting for a predetermined period of time. The time delay is determined based on the time/current characteristics of the interrupter and also takes into consideration the melt time of the fuse. The time delay allows the circuit to continue to operate when the voltage exceeds the high voltage setting of the interrupter for short periods of time. If the time delay allows the high voltage condition to continue too long and it exceeds the fuse melt time, the fuse will melt before the interrupter trips.

The assembly can include an electronic control package (“controller”) that is connected to the control module via a computer port and mounted external to the mechanism housing. The controller allows a user to monitor the current passing through the vacuum interrupter(s) and to program the control module for different temperature/current characteristics (TCC). The controller can also be used to program the setting for opening (i.e., tripping) the interrupter(s) at a predetermined condition.

The 35 kV current-limiting molded vacuum interrupter (CL-MVI) assembly is particularly well suited for use in wind farm towers as large as 3 MVA. The current-limiting MVI not only isolates a faulted tower, it also reduces arcing time and energy let-through (i.e., the amount of energy that passes through a device after a fault occurs) during a fault, thereby greatly reducing the likelihood of a catastrophic failure occurring within the tower. This also minimizes the chances of collateral equipment damage, tower damage and personal injury.

The design of the current-limiting fuse in a CL-MVI assembly is coordinated with the vacuum interrupter based on the transformer specifications so that the fuses will only operate (i.e., the fuse core is destroyed and the flow of electricity through the power line is interrupted) if a short circuit fault occurs inside the transformer or in the tower on the high voltage (HV) line between the transformer and the CL-MVI assembly. The interrupter clears all other faults and can easily be reset after repairs have been made. In the event that a transformer failure occurs and one or more of the fuses operate, the modular design makes it easy to quickly change out the fuse(s) after the transformer has been repaired or replaced.

The molded vacuum fault interrupters (MVI's) can be programmed with any desired fault settings, which are calculated using the melting time versus current curve for the high current interruption element of the fuse. The CL-MVIs of the present invention program a curve into the molded vacuum interrupter so that the interrupter trips at a high voltage setting and prevents the backup fuse from being overloaded. This allows current-limiting backup fuses suitable for operation at 35 kV to be made relatively short even after they are rubber molded. Combining programmed CL-MVIs and backup fuses creates a compact, fully dead-front protective device that provides not only overload and fault protection, but also current and energy limiting protection.

Furthermore, the ability of the MVI to quickly sense when a fuse has operated [PLEASE DESCRIBE HOW THIS IS DONE. DOES IT INVOLVE THE CURRENT SENSOR MEASURING A LOW VOLTAGE IN ONE PHASE AND THEN TRIPPING THE INTERRUPTERS FOR THE OTHER TWO PAHASES?] (when a phase has opened) and open all phases (e.g., in a 3-phase system, the other two phases) eliminates the voltage stress from the gap in the semi-conductive coating on the surface of the fuse. The gap, therefore, only has to be able to withstand 35 kV momentarily instead of indefinitely. Moreover, the combination allows a molded vacuum interrupter with a much lower interrupting rating to be used in a given application. When paired with a molded current-limiting backup fuse, the MVI only has to be capable of interrupting a current equal to the minimum interrupting current of the backup fuse as opposed to the maximum available fault current for the system.

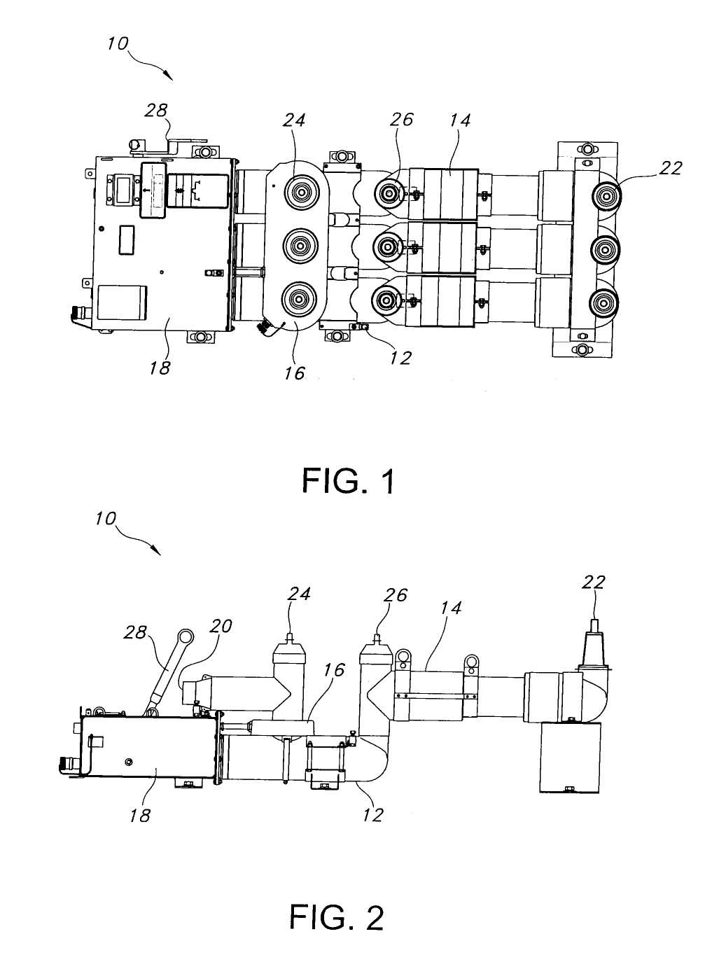

The molded vacuum interrupters and the molded backup fuses are connected in series. They can be connected and then enclosed in a single housing or they can be enclosed in separate housings that are connected together. For three-phase systems, the molded vacuum interrupters and the molded backup fuses can also be provided as three separate single phase assemblies or a single three-phase assembly as shown in FIGS. 1 and 2.

In another embodiment, the rubber molded current-limiting backup fuse is replaced by a sealed molded canister that is adapted to receive an un-molded fuse. In this embodiment, the entire Faraday cage is built into the rubber instead of being applied mostly on the outside of the fuse. Similar to the other embodiments, the fuse does not have to be able to withstand 35 kV indefinitely, just momentarily as described above.

Referring now to the drawings, FIGS. 1 and 2 show a top view and a side view, respectively, of a 3-phase embodiment of the 35 kV rubber molded fused vacuum interrupter assembly 10 that has three substantially identical lines; one for each of the three phases. In order to simplify the description of the figures, only one of the lines (i.e., a single-phase line) is described herein. However, one skilled in the art will understand that all three lines operate in substantially the same manner The vacuum interrupter assembly 10 includes a rubber molded vacuum interrupter 12, a rubber molded fuse 14 and a sensing module 16 that measures the current in the line and sends an electrical signal to a control module (FIG. 6, item 21). The vacuum interrupter 12 is operated by an actuator (FIG. 6, item 19) located inside the mechanism housing 18. FIG. 1 shows how the sensing module 16 is installed in a collar-like arrangement around each of the three lines in the assembly 10 to measure the current passing through the lines. The various different methods that are used to measure current in high voltage lines are well known to one skilled in the art.

FIG. 2 shows the connections 20, 22 for the 35 kV lines on either end of the assembly 10 and the test connections 24, 26 on either side of the interrupter 12 that can be used to determine if the interrupter 12 is open or closed. The mechanism housing 18 has a handle 28 on one side that can be used to manually operate the interrupter 12. The power line is connected to connector 20 and the electricity in the line first passes through the interrupter 12 and then passes through the fuse 14 to the outlet connector 22.

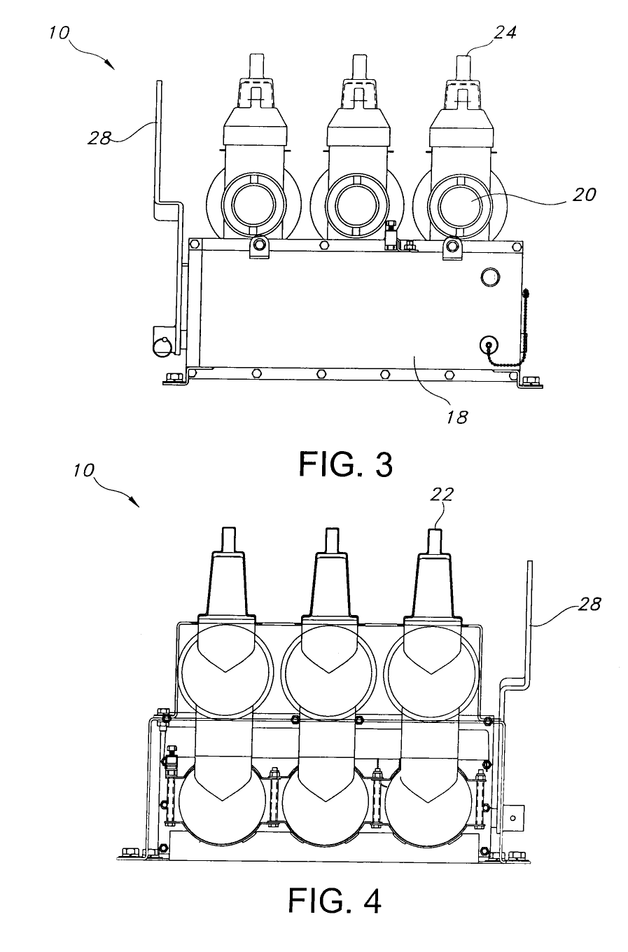

FIGS. 3 and 4 are views of the opposing ends of the 3-phase vacuum interrupter assembly 10. FIG. 3 shows the power line inlet connection 20 on the end of the assembly 10 with the mechanism housing 18 and handle 28. FIG. 4 shows the power line outlet connection 22 on the opposite end of the assembly 10.

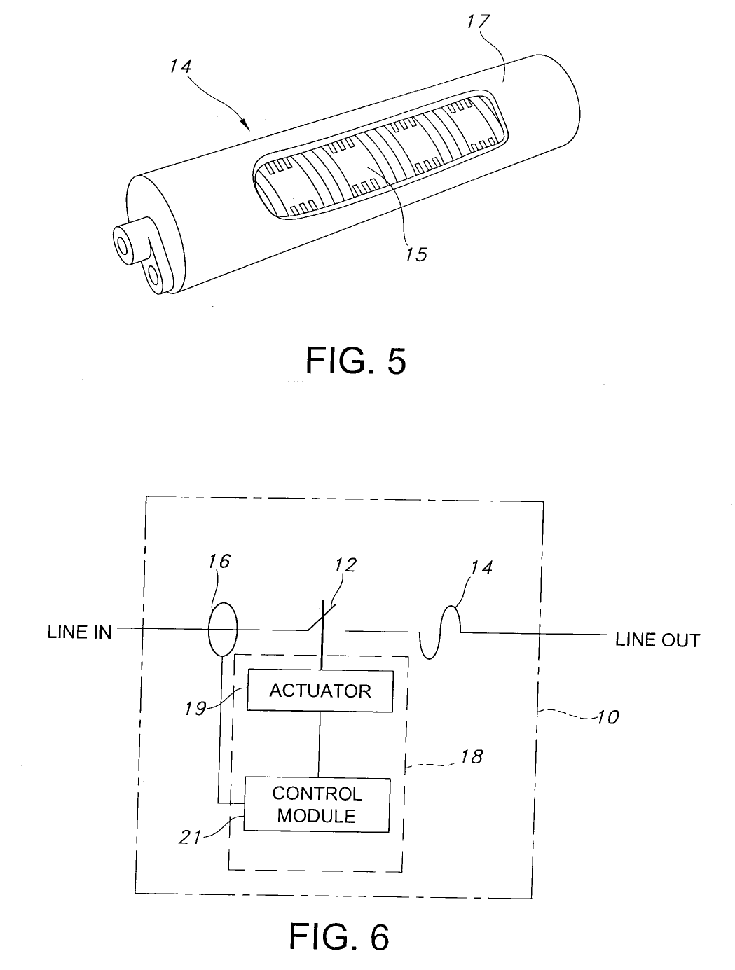

FIG. 5 shows a cut-away view of an embodiment of a rubber molded fuse 14 that can be used in the 35 kV rubber molded fused vacuum interrupter assembly 10 of the present invention. The rubber molded fuse 14 includes a high current interruption element 15 that is typically surrounded by sand or other inert material (not shown), which is packed into the housing 17. The high current interruption element 15 has a “punched ribbon” design and, because the fuse 14 is used with the molded vacuum interrupter 12, there is no need for the rubber molded fuse 14 to include a low current section. The vacuum interrupter assembly 10 is designed so that the molded vacuum interrupter 12 clears low fault currents and prevents the rubber molded fuse 14 from overheating. The molded fuse 14 only operates when there is a high fault current.

FIG. 6 is an electrical schematic of an embodiment of the 35 kV rubber molded fused vacuum interrupter assembly showing one high voltage line with the molded vacuum interrupter 12 connected in series with the rubber molded fuse 14. The sensing module 16 measures the current in the line and sends a signal to the control module 21. If a fault occurs, the control module sends a signal to the actuator 19 to open the vacuum interrupter 12.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A high voltage, rubber molded, fused vacuum interrupter assembly for protecting an electrical circuit from fault currents, the assembly comprising:
one or more vacuum fault interrupters, wherein each of the one or more vacuum fault interrupters is contained in a molded insulating structure; and
one or more current limiting fuses, wherein each of the one or more current limiting fuses is encapsulated in a rubber molding;
wherein one of the one or more vacuum fault interrupters and one of the one or more current limiting fuses are connected in series in a phase of the electrical circuit and wherein the vacuum fault interrupter interrupts low current faults and the fuse operates to protect against high current faults in a high voltage electrical power line.

2. The high voltage, rubber molded, fused vacuum interrupter assembly according to claim 1, wherein assembly comprises three vacuum fault interrupters and three current limiting fuses.

3. The high voltage, rubber molded, fused vacuum interrupter assembly according to claim 1, further comprising one or more sensing modules for measuring current passing through each of the one or more vacuum fault interrupters.

4. The high voltage, rubber molded, fused vacuum interrupter assembly according to claim 3, further comprising at least one control module, wherein the at least one control module receives a current measurement signal from each of the one or more sensing modules and opens the one or more interrupters when a current measurement signal equal to a predetermined high voltage setting for the one or more interrupters is measured.

5. The high voltage, rubber molded, fused vacuum interrupter assembly according to claim 4, wherein a time/current characteristic curve for each of the one or more interrupters is programmed in the at least one control module.

6. The high voltage, rubber molded, fused vacuum interrupter assembly according to claim 5, wherein the predetermined high voltage setting is based on the time/current characteristic curve.

7. The high voltage, rubber molded, fused vacuum interrupter assembly according to claim 4, further comprising a controller for monitoring the at least one control module and for reprogramming the predetermined high voltage setting for each of the one or more interrupters.

8. The high voltage, rubber molded, fused vacuum interrupter assembly according to claim 1, wherein each of the one or more vacuum fault interrupters has a predetermined high voltage setting and each of the one or more current limiting fuses has a rated interrupting current, and wherein the rated interrupting current is greater than the predetermined high voltage setting.

9. The high voltage, rubber molded, fused vacuum interrupter assembly according to claim 1, wherein the one or more vacuum fault interrupters are individually controlled by one or more actuators, wherein each actuator switches one of the one or more interrupters from a closed position, wherein current passes through the interrupter to an open position, wherein current does not pass through the interrupter.

10. The high voltage, rubber molded, fused vacuum interrupter assembly according to claim 9, wherein the one or more actuators and at least one control module for operating the one or more actuators are contained in a mechanism housing.

11. A high voltage, rubber molded, fused vacuum interrupter assembly for protecting an electrical circuit from fault currents, the assembly comprising:
one or more vacuum fault interrupters, wherein each of the one or more vacuum fault interrupters is contained in a molded insulating structure and wherein each of the vacuum fault interrupters has a predetermined high voltage setting;
one or more actuators for individually controlling the one or more vacuum fault interrupters, and
one or more current limiting fuses, wherein each of the one or more current limiting fuses is encapsulated in a rubber molding, and wherein each of the one or more current limiting fuses has a rated interrupting current;
wherein one of the one or more vacuum fault interrupters and one of the one or more current limiting fuses are connected in series in a phase of the electrical circuit, wherein the rated interrupting current is greater than the predetermined high voltage setting, and wherein the vacuum fault interrupter interrupts low current faults and the fuse operates to protect against high current faults in a high voltage electrical power line.

12. The high voltage, rubber molded, fused vacuum interrupter assembly according to claim 11, wherein the assembly comprises three vacuum fault interrupters and three current limiting fuses, wherein the actuators switch the interrupters from a closed position, wherein current passes through the interrupters to an open position, wherein current does not pass through the interrupters.

13. The high voltage, rubber molded, fused vacuum interrupter assembly according to claim 11, further comprising one or more sensing modules for measuring current passing through each of the one or more vacuum fault interrupters.

14. The high voltage, rubber molded, fused vacuum interrupter assembly according to claim 13, further comprising at least one control module, wherein the at least one control module receives a current measurement signal from each of the one or more sensing modules and opens the one or more interrupters when a current measurement signal equal to the predetermined high voltage setting for the one or more interrupters is measured.

15. The high voltage, rubber molded, fused vacuum interrupter assembly according to claim 14, wherein a time/current characteristic curve for each of the one or more interrupters is programmed in the at least one control module.

16. The high voltage, rubber molded, fused vacuum interrupter assembly according to claim 15, wherein the predetermined high voltage setting is based on the time/current characteristic curve.

17. The high voltage, rubber molded, fused vacuum interrupter assembly according to claim 14, further comprising a controller for monitoring the at least one control module and for reprogramming the predetermined high voltage setting for each of the one or more interrupters.

18. The high voltage, rubber molded, fused vacuum interrupter assembly according to claim 11, wherein the one or more actuators and at least one control module for operating the one or more actuators are contained in a mechanism housing.

19. A high voltage, rubber molded, fused vacuum interrupter assembly for protecting a three-phase electrical circuit from fault currents, the assembly comprising:
three vacuum fault interrupters, wherein each of the vacuum fault interrupters is contained in a molded insulating structure and wherein each of the vacuum fault interrupters has a predetermined high voltage setting;
three actuators for individually controlling the vacuum fault interrupters, wherein the actuators switch the interrupters from a closed position, wherein current passes through the interrupters to an open position, wherein current does not pass through the interrupters;
three sensing modules for measuring current passing through each of the vacuum fault interrupters;
at least one control module, wherein the at least one control module receives a current measurement signal from each of the three sensing modules and opens at least one of the interrupters when a current measurement signal equal to the predetermined high voltage setting for one of the interrupters is measured; and
three current limiting fuses, wherein each of the current limiting fuses is encapsulated in a rubber molding, and wherein each of the current limiting fuses has a rated interrupting current;
wherein one vacuum fault interrupter and one current limiting fuse are connected in series for each phase of the three-phase electrical circuit, wherein the rated interrupting current is greater than the predetermined high voltage setting for each phase, and wherein the vacuum fault interrupter interrupts low current faults and the fuse operates to protect against high current faults in each phase of the three-phase electrical circuit.

20. The high voltage, rubber molded, fused vacuum interrupter assembly according to claim 19, further comprising a controller for monitoring the at least one control module and for reprogramming the predetermined high voltage setting for each of the interrupters.
